(19) United States
(12) Patent Application Publication
(10) Pub. No.: US 2011/0094242 A1
(43) Pub. Date: Apr. 28, 2011

(54) Method and Apparatus for Generating Sustainable, Study State Power and Cooling from a Intermittent Power Source using Renewable Energy as a Primary Power Source

(76) Inventor: Matthew Douglas Koerner, Houston, TX (US)

(21) Appl. No.: 12/852,461

(22) Filed: Aug. 7, 2010

Related U.S. Application Data
(60) Provisional application No. 61/254,739, filed on Oct. 25, 2009.

(51) Int. Cl. F02C 3/28

(52) U.S. Cl. 60/780

(57) ABSTRACT

A device to generate a cooling fluid for a cooling load may include a first renewable energy source to generate renewable energy, a hydrogen generator connected to the first renewable energy source to generate hydrogen from the renewable energy, a first storage device to store the hydrogen generated by the hydrogen generator, a energy converter to convert the stored hydrogen to exhaust gas, a recuperator device to accept the exhaust gas to recoup the heat from the exhaust gas and an expander to reduce the temperature of the exhaust gas from the recuperator device one to form the cooling fluid for the cooling load. The extender may include a high-pressure expander, and the expander may include a low-pressure expander. The device may further include a second renewable energy source to generate renewable energy, a motor to operate from the renewable energy of the second renewable energy source, a compressor to compress fluid and connected to the motor and the compressed fluid may be stored in a second storage device.

### PRIORITY

The present invention claims priority under 35 USC section 119 and based upon a provisional application 61/254, 739 which was filed Oct. 25, 2009

### FIELD OF THE INVENTION

The present invention relates to a intermittent power source and more particularly to a intermittent renewable energy power source to provide steady-state power.

### BACKGROUND

Renewable power supplies are generally desirable in light of the impact on the environment. Among the renewable power supplies, wind, solar and water are among the most popular and these renewable power supplies have received a great deal of attention. However, a disadvantage of these renewable power supplies is the source of the power supply may be unreliable. More particularly, the wind may not be available 24//7 and solar is available generally only during daylight hours. These deficiencies result in the need for a conventional power source to back up the renewable powered supplies. This adds cost and additional equipment to provide a reliable power supply. Most facilities are not able to only use the power from these renewable power sources when power is available from the renewable power sources.

Batteries to store the power are an alternative from the unavailability of the renewable power sources. However, the power for a large commercial or industrial establishment is sufficiently large to result in the need for huge batteries. Backup generation may be available on site but generally uses fossil fuels which may harm the environment and may not be available in remote areas.

Furthermore, locations where grid power is not available, a reliable source of power is desirable.

What is required is an original power source, a method and apparatus of converting the power source into a reliable and steady flow of power and a constant voltage and frequency and lastly a method of storing the energy when it is not in use for use when the power source may not be available.

### SUMMARY

A device to generate a cooling fluid for a cooling load may include a first renewable energy source to generate renewable energy, a hydrogen generator connected to the first renewable energy source to generate hydrogen from the renewable energy, a first storage device to store the hydrogen generated by the hydrogen generator, an energy converter to convert the stored hydrogen to exhaust gas, a recuperator device to accept the exhaust gas to recoup the heat from the exhaust gas and an expander to reduce the temperature of the exhaust gas from the recuperator device one to form the cooling fluid for the cooling load.

The extender may include a high-pressure expander, and the expander may include a low-pressure expander.

The device may further include a second renewable energy source to generate renewable energy, a motor to operate from the renewable energy of the second renewable energy source, a compressor to compress fluid and connected to the motor and the compressed fluid may be stored in a second storage device.

The compressed fluid from the second storage device may be in fluid communication with the recuperator device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a system diagram of the system of the present invention in an on peak mode.

FIG. 2 illustrates a system diagram of a system of the present invention in an off-peak mode;

FIG. 3 illustrates a system diagram of another system of the present invention in an on-peak mode;

FIG. 4 illustrates a system diagram of the system of FIG. 3 of the present invention in an off-peak mode.

### DETAILED DESCRIPTION OF THE INVENTION

The present invention satisfies the three requirements for a steady stream of power supply. The present invention provides a power source which may include a renewable source of power which may include wind power, solar power and wave/tidal power. These renewable sources of power may have periods of time where the renewable source of power is simply not available. Consequently, there is a need to store the output of these renewable sources of power in order to provide power for use when the renewable source of power is not available. The stored power should be dispensed at a constant rate as required by the consumer. There are many ways to accomplish this distribution of power but distributing the power without using a carbon-based fuel is more challenging. With the present invention the power is filtered through a net metering device to the consumer. Excess power is stored by compressed air which has been compressed with an air compressor and the compressed air can be stored in aboveground tanks or in underground caverns such as porous limestone, caves, or salt domes. Alternatively the excess energy can be used to create hydrogen from water by a hydrogen electrolizer device.

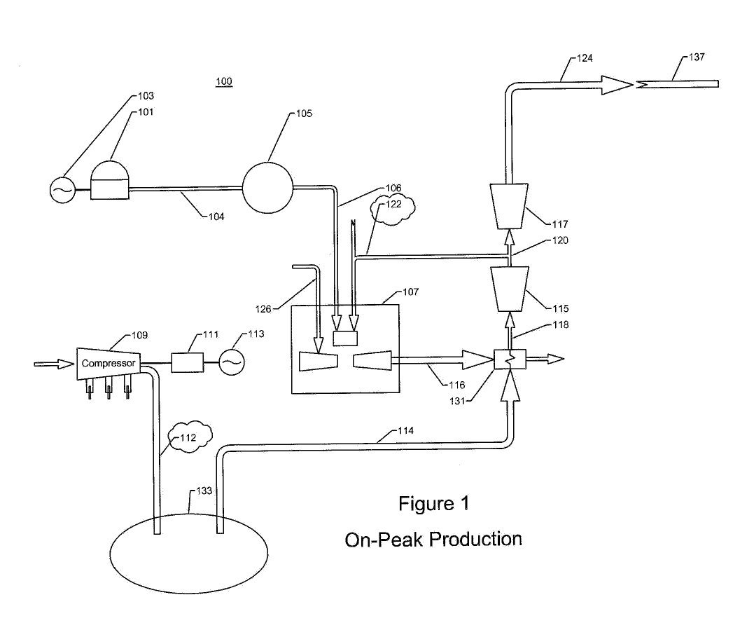

The power system 100 as illustrated in FIG. 1 (on peak production for the renewable energy sources) of the present invention may include a hydrogen generator 101 which may be connected to a first renewable power source 103 of electricity which may be any of the above renewable power sources. and which may be a hydrogen electrolyzer 101 or other source of hydrogen. The hydrogen electrolyzer 101 may be in fluid communication through a first passageway 104 at any approximate low flow rate with a hydrogen storage device 105 to store the hydrogen generated from the hydrogen electrolyzer 101. The hydrogen generator may obtain electricity from the first renewable power source 103 and apply the electricity to water which may be formed from hydrogen and oxygen in order to separate the water into the hydrogen and oxygen. The present invention discloses flow rates which may be generally relative with respect to other flow rates described in the present invention. Additionally, these flow rates are only one embodiment of the present invention. The hydrogen and oxygen are separated and the hydrogen is transmitted to the hydrogen storage device 105. The hydrogen storage device 105 may be in fluid communication by a second passageway 106 at an approximate standard rate with an energy converter 107 which may be a combustion turbine generator which may compress a air/fuel mixture and apply the compressed air/fuel mixture to an ignition source which may rotate a turbine to turn a generator/alternator in order to generate electricity. The energy converter 107 may receive a fluid which may be air and a standard approximate flow rate through the passageway 126 The generated electricity may be applied to a net metering equipment (not shown in FIG. 1) in order to supply a residence or other use for the electricity order to supply the electricity to the electrical grid.

The present invention may include a second renewable power source 113 which may be any of the renewable power sources that have been described above. The second renewable power source 113 may be connected to a motor 111 which may be connected to and which may rotate in order to operate a fluid compressor 109 which may compress a fluid which may be air or other suitable fluid and which is input to the fluid compressor 109. The fluid compressor 109 may be in fluid communication 112 with a fluid storage device 133 which may be a tank, cave or cavern or other suitable storage facilities for storing the fluid once it has been compressed by the fluid compressor 109. On-demand, the compressed fluid within the fluid storage device 133 flows to the recuperator device 131 which may be in fluid communication by the passageway 114 at any approximate standard flow rate with the fluid storage device 133 and which maybe in fluid communication by the passageway 116 at a substantial low flow rate with the energy converter 107. The recuperator device 131 may receive the exhaust from the energy converter 107 by the passageway 116. The recuperator may be a counter-flow energy recovery heat exchanger used to recover waste heat from exhaust gases. In many types of processes, combustion is used to generate heat, and the recuperator 131 serves to recuperate, or reclaim this heat, in order to reuse or recycle it and may be in fluid communication by the passageway 118 with the first expander 115. The output of the first expander 115 may be in fluid communication by the passageway 120 with the input of the second expander 117 and may be in fluid communication by the passageway 120 and the passageway 122 with the input to the energy converter 107. The first expander 115 may be a high-pressure expander while the second expander 117 may be a low-pressure expander, and the output of the second expander 117 may be in fluid communication by the passageway 124 at a substantially standard flow rate to a cooling load 137.

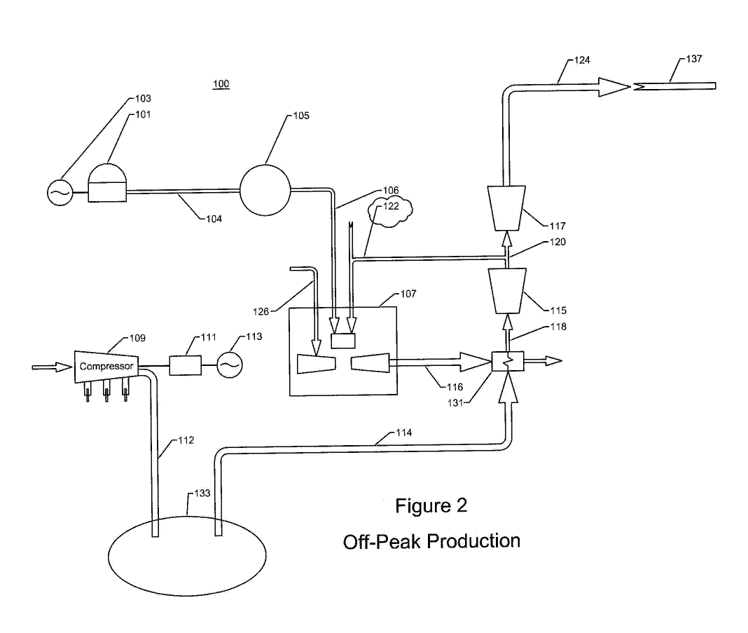

The power system 100 of the present invention may include a hydrogen generator 101 as illustrated in FIG. 2 (off-peak production when referring to the renewable energy sources) which may be connected to a first renewable power source 103 of electricity which may be any of the above renewable power sources, and which may be a hydrogen electrolyzer 101 or other source of hydrogen. The hydrogen electrolyzer 101 may be in fluid communication through a first passageway 104 at any approximate low flow rate with a hydrogen storage device 105 to store the hydrogen generated from the hydrogen electrolyzer 101. The hydrogen generator may obtain electricity from the first renewable power source 103 and apply the electricity to water which may be formed from hydrogen and oxygen in order to separate the water into the hydrogen and oxygen. The present invention discloses flow rates which may be generally relative with respect to other flow rates described in the present invention. Additionally, these flow rates are only one embodiment of the present invention. The hydrogen and oxygen are separated and the hydrogen is transmitted to the hydrogen storage device 105. The hydrogen storage device 105 (a first storage device) may be in fluid communication by a second passageway at an approximate standard rate with an energy converter 107 which may be a combustion turbine generator which may compress a air/fuel mixture and apply the compressed air/fuel mixture to an ignition source which may rotate a turbine to turn a generator/alternator in order to generate electricity. The generated electricity may be applied to a net metering equipment (not shown in FIG. 1) in order to supply a residence or other use for the electricity order to supply the electricity to the electrical grid.

The present invention may include a second renewable power source 113 which may be any of the renewable power sources that have been described above. The second renewable power source 113 may be connected to a motor 111 which may be connected to and which may rotate in order to operate a fluid compressor 109 which may compress a fluid which may be air or other suitable fluid. The fluid compressor 109 may be in fluid communication with a fluid storage device 133 (the second storage device) which may be a tank or cavern or other suitable storage facilities for storing the fluid once it has been compressed by the fluid compressor 109. On-demand, the compressed fluid within the fluid storage device 133 flows to the recuperator device 131 which may be in fluid communication by the passageway 114 with the fluid storage device 133 and which maybe in fluid communication by the passageway 116 with the energy converter 107. The recuperator device 131 may receive the exhaust from the energy converter 107 by the passageway 116. The recuperator may be a counter-flow energy recovery heat exchanger used to recover waste heat from exhaust gases. In many types of processes, combustion is used to generate heat, and the recuperator 131 serves to recuperate, or reclaim this heat, in order to reuse or recycle it and may be in fluid communication by the passageway 118 with the first expander 115. The output of the first expander 115 may be in fluid communication by the passageway 120 with the input of the second expander 117 and may be in fluid communication by the passageway 120 and the passageway 122 with the input to the energy converter 107. The first expander 115 may be a high-pressure expander while the second expander 117 may be a low-pressure expander, and the output of the second expander 117 may be in fluid communication by the passageway 124 to a cooling load 137.

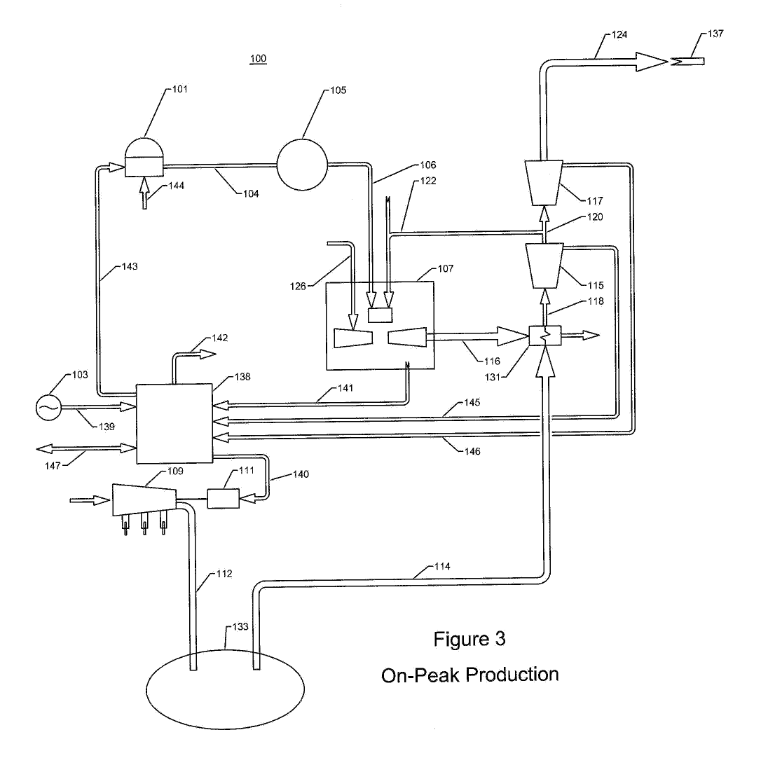

FIG. 3 illustrates a system diagram of another system of the present invention which may include a net metering equipment 138 which may receive power from the renewable power source 103 over the passageway 139 and may receive power from the energy converter 107 over the passageway 141 and from the first expander 115 over the passageway 145 and the second expander 117 over the passageway 146. The net metering equipment 138 meters and transmits the power received to the load 142. Excess power which may not be required by the load 142 may be transferred to the hydrogen electrolyzer 101 over the passageway 143 (the hydrogen electrolyzer 101 may require water from a source 144). The net meter 138 may power the fluid compressor 109 or the motor 111 by the passageway 140. If a power shortage should develop, the shortage of power can be obtained from the power grid 147 or excess power may be output to the power grid 147.

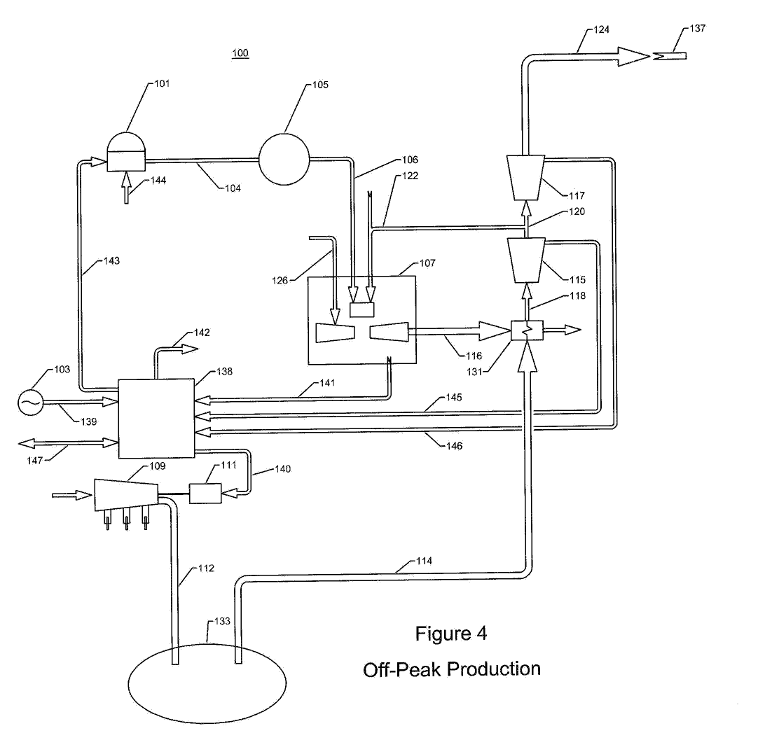

FIG. 3 illustrates the system operation during on peak production while FIG. 4 illustrates the off-peak production.

FIG. 43 illustrates a system diagram of another system of the present invention which may include a net metering equipment 138 which may receive power from the renewable power source 103 over the passageway 139 and may receive power from the energy converter 107 over the passageway 141 and from the first expander 115 over the passageway 145 and the second expander 117 over the passageway 146. The net metering equipment 138 meters and transmits the power received to the load 142. Excess power which may not be required by the load 142 may be transferred to the hydrogen electrolyzer 101 over the passageway 143 (the hydrogen electrolyzer 101 may require water from a source 144). The net meter 138 may power the fluid compressor 109 or the motor 111 by the passageway 140. If a power shortage should develop, the shortage of power can be obtained from the power grid 147 or excess power may be output to the power grid 147.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device to generate a cooling fluid for a cooling load, comprising:
a first renewable energy source to generate renewable energy;
a hydrogen generator connected to the first renewable energy source to generate hydrogen from the renewable energy;
a first storage device to store the hydrogen generated by the hydrogen generator;
a energy converter to convert the stored hydrogen to exhaust gas;
a recuperator device to accept the exhaust gas to recoup the heat from the exhaust gas;
an expander to reduce the temperature of the exhaust gas from the recuperator device one to form the cooling fluid for the cooling load.

2) A device to generate a cooling fluid for a cooling load as in claim 1, wherein the expander includes a high-pressure expander.

3) A device to generate a cooling fluid for a cooling load as in claim 1, wherein the expander includes a low-pressure expander.

4) A device to generate a cooling fluid for a cooling load as in claim 1, wherein the device further includes:
a second renewable energy source to generate renewable energy;
a motor to operate from the renewable energy of the second renewable energy source;
a compressor to compress fluid and connected to the motor;
wherein the compressed fluid is stored in a second storage device.

5) A device to generate a cooling fluid for a cooling load as in claim 4, wherein the compressed fluid from the second storage device is in fluid communication with the recuperator device.
